(19) United States
(12) Patent Application Publication
(10) Pub. No.: US 2025/0103963 A1
(43) Pub. Date: Mar. 27, 2025

(54) METHOD FOR PROCESSING QUERY-RESPONSE INFORMATION, METHOD FOR TRAINING MODEL, ELECTRONIC DEVICE AND MEDIUM

(71) Applicant: Beijing Baidu Netcom Science Technology Co., Ltd., Beijing (CN)

(72) Inventors: Xin TIAN, Beijing (CN); Yang YANG, Beijing (CN); Ji LUO, Beijing (CN); Huang HE, Beijing (CN); Siqi BAO, Beijing (CN); Bingjin CHEN, Beijing (CN); Hua WU, Beijing (CN)

(21) Appl. No.: 18/969,634

(22) Filed: Dec. 5, 2024

(30) Foreign Application Priority Data
Sep. 20, 2024 (CN) 202411320303.1

(51) Int. Cl. G06N 20/00

(52) U.S. Cl. CPC G06N 20/00

(57) ABSTRACT

A method for processing a query-response information is provided, which relates to a field of artificial intelligence technology, and in particular to fields of deep learning, large models, intelligent query and response, etc. The method for processing a query-response information includes: generating at least one initial response information according to a query information provided by an object; acquiring at least one feedback information corresponding to the at least one initial response information, wherein the feedback information indicates a preference degree of the object for the initial response information; and generating a training sample according to the query information, the at least one initial response information and the at least one feedback information. The present disclosure further provides a method for training a conversational model, an electronic device, and a storage medium.

This application claims the benefit of priority to Chinese Patent Application No. 2024113203031, filed on Sep. 20, 2024. The entire contents of this application are hereby incorporated herein by reference.

### TECHNICAL FIELD

The present disclosure relates to a field of artificial intelligence technology, in particular to fields of deep learning, large models, intelligent query and response, etc., and more specifically to a method for processing a query-response information, a method for training a model, an electronic device, and a storage medium.

### BACKGROUND

With the development of artificial intelligence technology, the application scenes of conversational models are becoming increasingly diverse.

### SUMMARY

The present disclosure provides a method for processing a query-response information, a method for training a conversational model, a device, and a storage medium.

According to an aspect of the present disclosure, a method for processing a query-response information is provided, including: generating at least one initial response information according to a query information provided by an object; acquiring at least one feedback information corresponding to the at least one initial response information, wherein the feedback information indicates a preference degree of the object for the initial response information; and generating a training sample according to the query information, the at least one initial response information and the at least one feedback information.

According to another aspect of the present disclosure, a method for training a conversational model is provided, including: adjusting a parameter of the conversational model according to at least one training sample, so that the conversational model generates an adjusted response information according to a query information in the training sample, wherein a difference between the adjusted response information and a response information with a high preference degree in the training sample is small, and a difference between the adjusted response information and a response information with a low preference degree in the training sample is large. The training sample is generated by: generating at least one initial response information according to a query information provided by an object; acquiring at least one feedback information corresponding to the at least one initial response information, wherein the feedback information indicates a preference degree of the object for the initial response information; and generating the training sample according to the query information, the at least one initial response information and the at least one feedback information.

According to another aspect of the present disclosure, an electronic device is provided, including: at least one processor; and a memory communicatively connected with the at least one processor; where the memory stores instructions executable by the at least one processor, and the instructions, when executed by the at least one processor, are used to cause the at least one processor to perform the methods provided by the present disclosure.

According to another aspect of the present disclosure, a non-transitory computer-readable storage medium having computer instructions stored therein is provided, where the computer instructions are used to cause the computer to perform the methods provided by the present disclosure.

It should be understood that the content described in this section is not intended to identify key or important features of embodiments of the present disclosure, nor is it intended to limit the scope of the present disclosure. Other features of the present disclosure will be easily understood through the following description.

### BRIEF DESCRIPTION OF THE DRAWINGS

The drawings are used to better understand the solutions, and do not constitute a limitation to the present disclosure, in which:

FIG. 1 is a schematic diagram of an exemplary system architecture to which a method and an apparatus for processing a query-response information may be applied according to an embodiment of the present disclosure;

FIG. 2 is a flow chart of a method for processing a query-response information according to an embodiment of the present disclosure;

FIG. 3 is a principle diagram of a method for processing a query-response information according to an embodiment of the present disclosure;

FIG. 4 is a schematic flow chart of a method for training a conversational model according to another embodiment of the present disclosure;

FIG. 5 is a schematic principle diagram of a method for training a model according to an embodiment of the present disclosure;

FIG. 6 is a block diagram of an apparatus for processing a query-response information according to an embodiment of the present disclosure;

FIG. 7 is a block diagram of an apparatus for training a conversational model according to another embodiment of the present disclosure; and

FIG. 8 is a block diagram of an electronic device for implementing a method for processing a query-response information and/or a method for training a conversational model according to an embodiment of the present disclosure.

### DETAILED DESCRIPTION OF EMBODIMENTS

Hereinafter, embodiments of the present disclosure will be described with reference to the drawings. It should be understood, however, that these descriptions are merely exemplary and are not intended to limit the scope of the present disclosure. In the following detailed description, for ease of interpretation, many specific details are set forth to provide a comprehensive understanding of embodiments of the present disclosure. However, it is clear that one or more embodiments may also be implemented without these specific details. In addition, in the following description, descriptions of well-known structures and technologies are omitted to avoid unnecessarily obscuring the concepts of the present disclosure.

Large models may include a large language model (LLM), a large image model, a large video model, etc. Taking the large language model as an example, a large-scale unsupervised corpus may be used for pre-training, and then supervised fine-tuning (SFT) training may be performed using supervised fine-tuning corpus carefully tagged by experts in related fields. Next, alignment training may be performed using alignment algorithms such as Kahneman-Tversky Optimization (KTO), Direct Preference Optimization (DPO), Simple Preference Optimization (simPO), and Proximal Policy Optimization (PPO). The upper limit of model performance depends on the quantity and quality of the supervised fine-tuning corpus and the effect of the reward model in the alignment training phase.

In some embodiments, the effect of the model is highly correlated with the quantity and quality of the training sample. For most models, the corpus may be tagged by experts in related fields to continuously improve the quality of the corpus. However, the cost of tagging is high and the efficiency is low.

In some embodiments, for the target application scene, the data mining process may be customized to continuously mine queries that are difficult for the model to response with high quality in the target application scene, thereby improving the tagging efficiency of experts in related fields. However, in the mining process, the behavioral signals of user are not fully used, and the direction of improving the model effect is difficult to be consistent with the direction of improving the user experience. Therefore, in order to fully improve the performance of the model and user experience, the present disclosure provides a method for processing a query-response information, which will be described below.

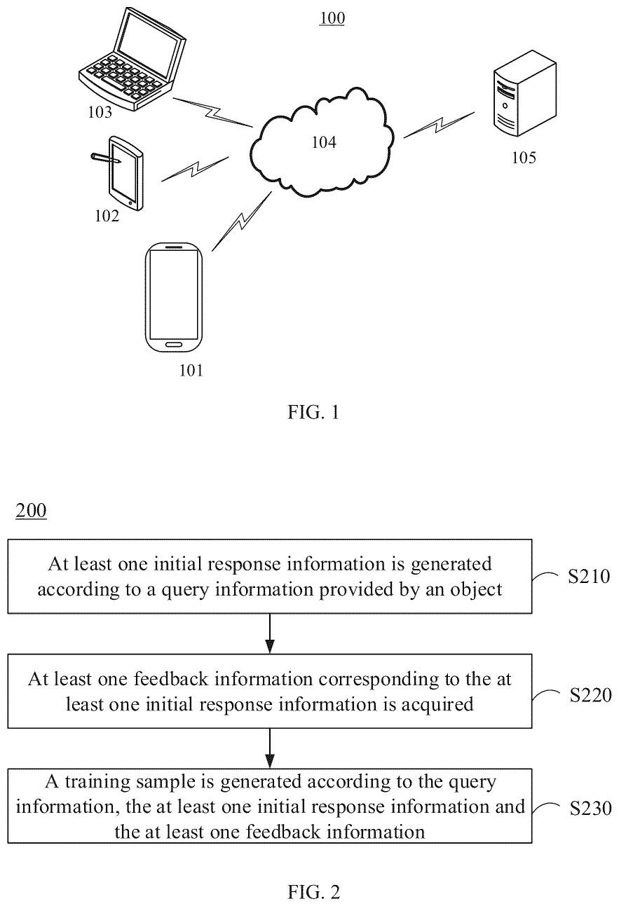

FIG. 1 schematically shows an exemplary system architecture to which a method for processing a query-response information and an apparatus for processing a query-response information may be applied according to an embodiment of the present disclosure. It should be noted that FIG. 1 is just an example of the system architecture to which embodiments of the present disclosure may be applied to help those skilled in the art to understand the technical content of the present disclosure, but it does not mean that embodiments of the present disclosure may not be used in other environments or scenes.

As shown in FIG. 1, the system architecture 100 according to this embodiment may include terminal devices 101, 102, 103, a network 104 and a server 105. The network 104 is used to provide a medium for a communication link between the terminal devices 101, 102, 103 and the server 105. The network 104 may include various connection types, such as wired and/or wireless communication links, etc.

The terminal devices 101, 102 and 103 may be used by the user to interact with the server 105 through the network 104 to receive or send messages, etc. The terminal devices 101, 102 and 103 may be various electronic devices having a display screen and supporting web browsing, including but not limited to smart phones, tablet computers, laptop computers, and desktop computers.

The server 105 may be a server that provides various services, such as a background management server that provides support for the content browsed by the user using the terminal devices 101, 102 and 103 (only as an example). The background management server may analyze and process the received data such as user requests, and feedback the processing results (such as web pages, information, or data obtained or generated according to user requests) to the terminal devices.

It should be noted that the method for processing a query-response information provided by embodiments of the present disclosure may be generally performed by the server 105. Accordingly, the apparatus for processing a query-response information provided by embodiments of the present disclosure may generally be arranged in the server 105. The method for processing a query-response information provided by embodiments of the present disclosure may also be performed by a server or server cluster that is different from the server 105 and may communicate with the terminal devices 101, 102, 103 and/or the server 105. Accordingly, the apparatus for processing a query-response information provided by embodiments of the present disclosure may also be arranged in a server or server cluster that is different from the server 105 and may communicate with the terminal devices 101, 102, 103 and/or the server 105.

It should be understood that the above describes the system architecture of the present disclosure, and the following will describe the method of the present disclosure.

FIG. 2 is a flow chart of a method for processing a query-response information according to an embodiment of the present disclosure.

As shown in FIG. 2, the method 200 may include operations S210 to S230.

In operation S210, at least one initial response information is generated according to a query information provided by an object.

In embodiments of the present disclosure, the object may include a user. The query information may include a query input by the user. For example, the query information may be information in various forms such as text, image, audio, video, etc.

In embodiments of the present disclosure, the initial response information may be generated in various methods. For example, the initial response information corresponding to the query information may be determined using a preset mapping relationship. Alternatively, the initial response information corresponding to the query information may be determined using a conversational model. The initial response information may be information in various forms such as text, image, audio, video, etc.

In operation S220, at least one feedback information corresponding to the at least one initial response information is acquired.

In embodiments of the present disclosure, the feedback information may indicate a preference degree of the object for the initial response information. For example, the feedback information may be provided by the user. It should be understood that after obtaining the authorization of the user, the query information and the feedback information provided by the user may be acquired.

In operation S230, a training sample is generated according to the query information, the at least one initial response information and the at least one feedback information.

In embodiments of the present disclosure, it is possible to determine multi-tuple data as the training sample according to the query information, the at least one initial response information and the at least one feedback information.

Through embodiments of the present disclosure, the feedback information provided by the object for the initial response information may be acquired, the dependence on experts in related fields is reduced, and the tagging cost of experts may be greatly reduced. By acquiring the feedback information, more realistic user preferences may be acquired. The training sample generated based on the query information, the initial response information and the feedback information may make the generated response information closer to the real preference of the user, which may fully improve the user experience.

It should be understood that the method of the present disclosure is described above, and some methods of generating the initial response information in the present disclosure will be described below.

In some embodiments, in some implementations of the operation S210, at least one initial response information is generated using a conversational model based on the query information provided by the object.

For example, the conversational model may be a large model or a lightweight model applied to the target application scene.

For example, the conversational model may perform the audio recognition according to the query information of an audio type provided by the user, so as to determine the semantics of the query information. Next, the conversational model may generate an initial response information of the audio type or an initial response information of the type corresponding to the semantics. For another example, the conversational model may determine the semantics of the query information based on the query information of a text type provided by the user, so as to determine the corresponding initial response information. It should be understood that the method in which the conversational model generates the initial response information based on the query information of an image type and the query information of a video type is the same or similar to the method in which the initial response information is generated based on the query information of the audio type, and the present disclosure will not repeat it here. Through embodiments of the present disclosure, the conversational model may be used to more accurately determine the response information and improve the user experience.

It should be understood that the above describes some methods of generating the initial response information in the present disclosure, and the feedback information of the present disclosure will be described below.

In some embodiments, the feedback information may include a preference degree value.

In embodiments of the present disclosure, the preference degree value is determined according to one of the plurality of visual controls triggered by the user, the plurality of visual controls include a first visual control and a second visual control, and the preference degree value corresponding to the first visual control is greater than the preference degree value corresponding to the second visual control.

In some embodiments, in some implementations of the operation S220 and the operation S230, the preference degree value corresponding to the initial response information is acquired, and the training sample is generated according to the query information, the initial response information and the feedback information.

For example, the query information of the user may be provided to the conversational model. The conversational model may generate the initial response information corresponding to the query information. If it is determined by the user that the initial response information has a high correlation with the query information, the first visual control may be triggered to determine the preference degree value of the initial response information as the first preference degree value. Then, a triple data may be generated as the training sample. The triple data may include the query information, the initial response information and the first preference degree value. It should be understood that the first visual control may be a “liked” control. The first preference degree value may be, for example, 1.

For another example, the query information of the user may be provided to the conversational model. The conversational model may generate the initial response information corresponding to the query information. If it is determined by the user that the initial response information has a low correlation with the query information, the second visual control may be triggered to determine the preference degree value of the initial response information as the second preference degree value. Then, a triple data may be generated as the training sample. The triple data may include the query information, the initial response information, and the second preference degree value. It should be understood that the second visual control may be a “dislike” control. The second preference degree value may be, for example, 0.

For another example, the triple data may be represented as <query, response, signal>, response may be the initial response information, signal may be the feedback signal information corresponding to the first preference degree value or the second preference degree value.

It should be understood that the triple data including the query information, the initial response information and the preference degree value may be pointwise preference data.

It should be understood that the above description uses the first preference degree value or the second preference degree value of the feedback information as an example to describe the present disclosure. However, the present disclosure is not limited to this, and the feedback information may also be a preference degree evaluation value provided by the object. For example, the value range of the preference degree evaluation value may be 0 to 100, and the greater the preference degree evaluation value, the more the initial response information conforms to the true preference of the user.

It should be understood that the above describes the method for generating pointwise preference data, and another type of preference data will be described below.

In some embodiments, in other embodiments of the method 200, a plurality of initial response information may be generated based on the query information provided by the object. A plurality of preference degree values corresponding to the plurality of initial response information are acquired. The training sample may be generated according to the query information, the plurality of initial response information and the plurality of preference degree values.

For example, the query information of the user may be provided to the conversational model. The conversational model may generate the plurality of initial response information. Alternatively, the same query information of the user may be provided to the conversational model multiple times to acquire the plurality of initial response information. A plurality of preference degree evaluation values may be determined by the user according to the plurality of initial response information, respectively. The plurality of preference degree evaluation values may indicate the preferences of the user for different initial response information. The plurality of preference degree evaluation values may be used as the feedback signal information. In this way, taking the case that the number of initial response information is N as an example, N-tuple data may be generated as the training sample. The N-tuple data may include the query information, N initial response information, and feedback signal information. For another example, the N-tuple data may be represented as <query, response1, . . . , responseN, signal>, where response1, . . . , responseN may be N initial response information, signal may be feedback signal information corresponding to N preference degree evaluation values, and N may be an integer greater than 1.

It should be understood that the N-tuple data may be pairwise preference data.

It should be understood that the above feedback information may be generated during the conversation between the object and the conversational model, and may be used as conversational feedback information. In the relevant application scene, the number of users of the conversational model is huge. The usage behavior (providing feedback) of the user plays an important role in improving the performance of the model. Through embodiments of the present disclosure, the evaluation results of the user on the response information generated by the conversational model may be acquired to obtain the feedback signal of the user in the real scene, which may effectively improve the performance of the conversational model.

It should be understood that the above description uses the feedback information as an example of the preference degree value to describe the present disclosure. However, the present disclosure is not limited to this, and the feedback information may also be a target response information provided by the object, which will be described below.

In some embodiments, the target application scene may be an artificial intelligence-assisted creation scene. For example, the target application scene may be a novel writing-assisted scene, an intelligent coding scene, and an intelligent presentation creation scene. The conversational model may recommend one or more contents according to the query information provided by the user. The user may directly adopt the recommended content and not edit the content, or not adopt the recommended content or partially adopt the recommended content. The content may be used as the initial response information.

In embodiments of the present disclosure, the acquiring at least one feedback information corresponding to the at least one initial response information includes: acquiring the target response information provided by the object and corresponding to the query information, wherein a correlation index value between the target response information and the initial response information is less than a preset correlation threshold. For example, if it is determined by the user that the quality of the recommended content is low, the user may not adopt the recommended content, and the user may write the target content by herself/himself. The correlation between the recommended content and the target content is low and may be lower than a preset correlation threshold. The target content may serve as the target response information corresponding to the query information.

In embodiments of the present disclosure, the acquiring at least one feedback information corresponding to the at least one initial response information includes: acquiring the target response information provided by the object and edited from the initial response information. For example, if it is determined by the user that the recommended content may be partially adopted, the user may edit the recommended content to obtain the target content. The target content may serve as the target response information.

In embodiments of the present disclosure, the triple data may be generated as the training sample according to the query information, the initial response information and the target response information. For example, the triple data may be represented as <query, response_before, response_after>, where response_before may be the initial response information, response_after may be the target response information. The triple data includes two response information and may also be used as the pairwise preference data.

It should be understood that in the case that the user directly adopts the recommended content without editing the content, it is difficult to generate the pairwise preference data based on the content. However, the preference degree value of the content may be determined as the first preference degree value to generate the pointwise preference data.

It should be understood that the feedback information is the target response information generated by object editing and may be used as an edit feedback information. In the relevant application scene, the user may modify and polish the result output by the model. Through embodiments of the present disclosure, the result modified and polished by the user is acquired as the target response information, and high-quality user preference data may be acquired, which may fully improve the performance of the conversational model.

It should be understood that the above description of the present disclosure is based on the example that the object is a user. However, the present disclosure is not limited to this, and the object may also be a large model, which will be describe below.

In embodiments of the present disclosure, the feedback information may be generated by the large model according to the preset feedback rule and the initial response information. For example, the conversational model may be a model on the terminal side, which is small in scale. The large model is large in scale, has good generation capabilities, and also has evaluation capabilities. Based on the preset feedback rules, the preference degree value may be determined as feedback information using the large model.

In embodiments of the present disclosure, the preset feedback rule may be determined according to the preferences of the user. For example, the preset feedback rule may include the number of words corresponding to the response information, the relevance to the query information, etc. The specific values of the number of words and relevance may be determined based on the preferences of the user.

For another example, the query information of the user may be provided to the conversational model. The conversational model may generate a plurality of initial response information. Alternatively, the same query information of the user may be provided to the conversational model multiple times to acquire the plurality of initial response information. Based on preset feedback rule, the large model may determine a plurality of preference degree evaluation values according to the plurality of initial response information, respectively. The plurality of preference degree evaluation values may also indicate the preferences of the user for different initial response information. The plurality of preference degree values may be used as the feedback signal information. In this way, taking the multiple initial response information as N initial response information as an example, N-tuple data may be generated as the training sample. N-tuple data may include the query information, N initial response information, and the feedback signal information. For another example, N-tuple data may be represented as <query, response1, . . . , responseN, signal′>, where response1, . . . , responseN may be N initial response information, signal′ may be the feedback signal information corresponding to the N preference degree evaluation values generated by the large model.

It should be understood that the above description uses the example of determining the preference degree value by the large model to describe the present disclosure. However, the present disclosure is not limited to this. In some embodiments, the large model may also generate the target response information. The target response information generated by the large model may also be used as the feedback information.

It should be understood that the above description uses the example of determining the feedback information by the large model to describe the present disclosure. However, the present disclosure is not limited to this. The large model may also provide query information to the conversational model.

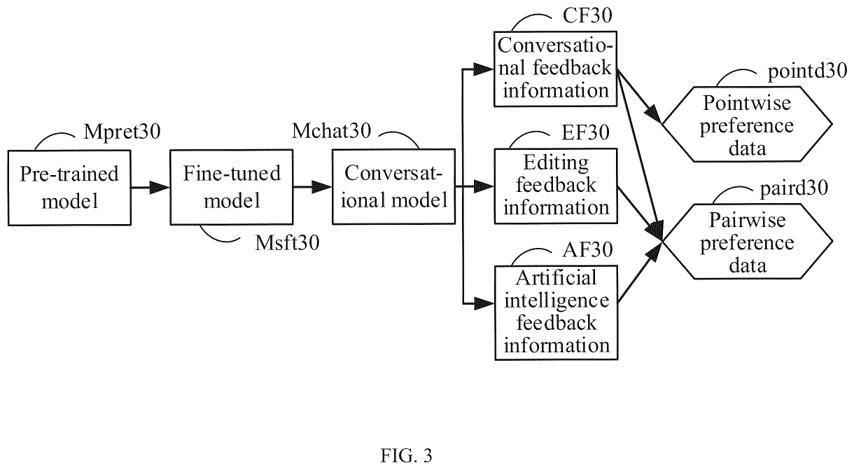

It should be understood that the feedback information is determined by the large model and may be used as artificial intelligence feedback (AI feedback) information. Through embodiments of the present disclosure, the evaluation ability of the large model may be fully utilized to improve the richness of the feedback information source, which helps to further improve the performance of the conversational model. The various feedback information of the present disclosure will be further described with reference to FIG. 3.

FIG. 3 is a principle diagram of a method for processing a query-response information according to an embodiment of the present disclosure.

As shown in FIG. 3, a model may be pre-trained to obtain a pre-trained model Mpret30. The supervised fine-tuning is performed on the pre-trained model Mpret30 to obtain a fine-tuned model Msft30. The fine-tuned model Msft30 may be used as a conversational model Mchat30. The conversational model Mchat30 may generate the initial response information according to the query information provided by the object. A conversational feedback information CF30, an editing feedback information EF30 and an artificial intelligence feedback information AF30 may be acquired based on the initial response information. Pointwise preference data pointd30 may be obtained based on the conversational feedback information CF30. Pairwise preference data paird30 may be obtained based on the conversational feedback information CF30, the editing feedback information EF30 and the artificial intelligence feedback information AF30. The pointwise preference data pointd30 and the pairwise preference data paird30 may be used as training samples.

It should be understood that the above describes the method of generating the training sample, and some methods of training model will be described below.

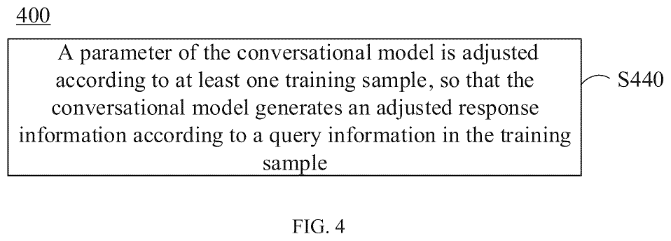

FIG. 4 is a schematic flow chart of a method for training a conversational model according to another embodiment of the present disclosure.

As shown in FIG. 4, the method 400 may include operation S440.

In operation S440, a parameter of the conversational model is adjusted according to at least one training sample, so that the conversational model generates an adjusted response information according to a query information in the training sample.

In embodiments of the present disclosure, the alignment training may be performed on the conversational model to adjust the parameter of the conversational model.

In embodiments of the present disclosure, a difference between the adjusted response information and a response information with a high preference degree in the training sample is small, and a difference between the adjusted response information and a response information with a low preference degree in the training sample is large.

In embodiments of the present disclosure, the training sample is generated by: generating at least one initial response information according to a query information provided by an object; acquiring at least one feedback information corresponding to the at least one initial response information, where the feedback information may indicate a preference degree of the object for the initial response information; and generating the training sample according to the query information, the at least one initial response information and the at least one feedback information. For example, the training sample may be generated by the above method 300.

Through embodiments of the present disclosure, the feedback information in the training sample may be at least one of the conversational feedback information, the editing feedback information, or the artificial intelligence feedback information, which provides different types of feedback signals for model training. These feedback signals are highly correlated with the preferences of the user in real scene, and may be used to align the model performance with the real preference of the user, thereby effectively improving the upper limit of the performance of the model, so that the model evolves in the direction of the real preference of the user. In addition, the sample tagging cost may also be reduced, and the efficiency of acquiring training sample may be improved.

It should be understood that the method for training model is described above, and the method for training model in the present disclosure will be further described below in combination with the various feedback information.

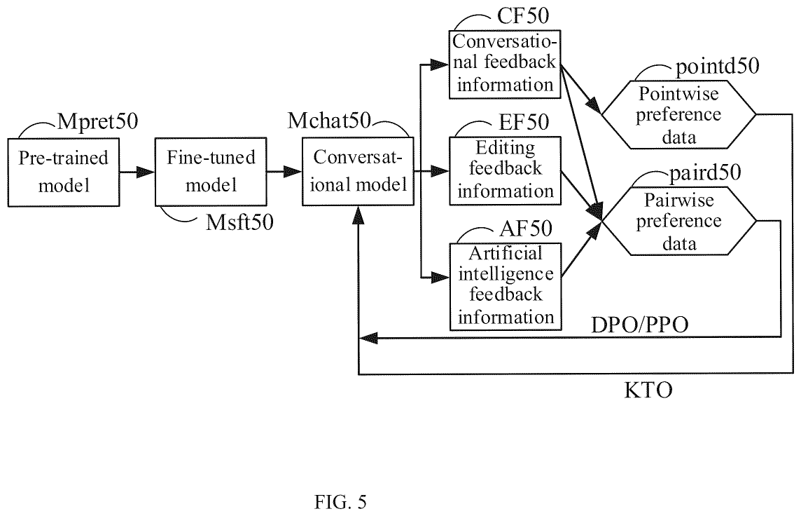

FIG. 5 is a schematic principle diagram of a method for training a model according to an embodiment of the present disclosure.

As shown in FIG. 5, a model may be pre-trained to obtain a pre-trained model Mpret50. The supervised fine-tuning is performed on the pre-trained model Mpret50 to obtain a fine-tuned model Msft50. The fine-tuned model Msft50 may be used as a conversational model Mchat50. The conversational model Mchat50 may generate the initial response information according to the query information provided by the object. A conversational feedback information CF50, an editing feedback information EF50 and an artificial intelligence feedback information AF50 may be acquired based on the initial response information. Pointwise preference data pointd50 may be obtained based on the conversational feedback information CF50. Pairwise preference data paird50 may be obtained based on the conversational feedback information CF50, the editing feedback information EF50 and the artificial intelligence feedback information AF50. The pointwise preference data pointd50 and the pairwise preference data paird50 may be used as training samples.

In embodiments of the present disclosure, the feedback information includes a preference degree value. The adjusting a parameter of the conversational model according to at least one training sample includes: adjusting the parameter of the conversational model according to the query information, the initial response information and the preference degree value in the training sample. The parameter of the conversational model may be adjusted based on the Kahneman-Tversky optimization (KTO) method. For example, the pointwise preference data pointd50 may include triple data <query, response, signal>. The triple data may include the query information, the initial response information and the preference degree value. The parameter of the conversational model may be adjusted based on the Kahneman-Tversky optimization method. The adjusted conversational model may generate the adjusted response information according to the query information in the triple data. The preference degree value of the adjusted response information may be greater than the preference degree value of the initial response information, for example.

It should be understood that the above description uses the pointwise preference data as an example to describe the present disclosure, but the present disclosure is not limited thereto, and the following description will be made using pairwise preference data as an example.

In embodiments of the present disclosure, the training sample includes a plurality of initial response information, and the feedback information includes a preference degree value. The adjusting a parameter of the conversational model according to at least one training sample includes: adjusting the parameter of the conversational model according to the query information, the plurality of initial response information, and respective preference degree values of the plurality of initial response information in the training sample. The parameter of the conversational model may be adjusted based on at least one of direct preference optimization (DPO), simple preference optimization (simPO), or proximal policy optimization (PPO). For example, the pairwise preference data may include the N-tuple data <query, response1, . . . , responseN, signal>. The N-tuple data may include the query information, N initial response information, and the feedback information. The feedback information may correspond to N preference degree values. For example, the parameter of the conversational model may be adjusted based on the direct preference optimization manner. The adjusted conversational model may generate an adjusted response information according to the query information in the N-tuple data. The preference degree value of the adjusted response information may be close to the highest value among the N preference degree values, for example.

It should be understood that the above description uses the pairwise preference data including N-tuple data as an example to describe the present disclosure, but the present disclosure is not limited thereto, and the pairwise preference data may also include triplet data, which will be described below.

In embodiments of the present disclosure, the feedback information includes a target response information provided by the object. The preference degree of the object for the target response information is greater than the preference degree of the object for the initial response information. The adjusting a parameter of the conversational model according to at least one training sample includes: adjusting the parameter of the conversational model according to the query information, the initial response information and the target response information in the training sample. The parameter of the conversational model may be adjusted based on at least one of direct preference optimization, simple preference optimization, or proximal strategy optimization. For example, the pairwise preference data may include the above triple data <query, response_before, response_after>. The triple data may include the query information, the initial response information, and the target response information. For example, the parameter of the conversational model may be adjusted based on the simple preference optimization manner. The adjusted conversational model may generate an adjusted response information according to the query information in the triple data. The preference degree of the object for the adjusted response information may be close to the preference degree of the object for the target response information, for example.

It should be understood that the methods in the present disclosure are described above, and the apparatuses of the present disclosure will be described below.

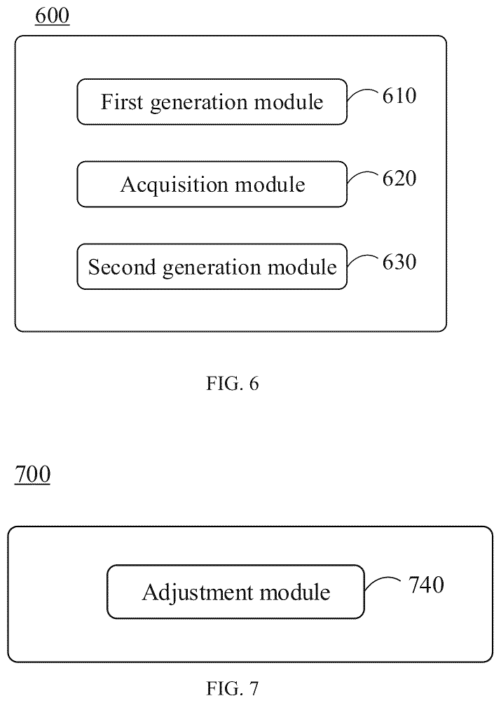

FIG. 6 is a block diagram of an apparatus for processing a query-response information according to an embodiment of the present disclosure.

As shown in FIG. 6, the apparatus 600 may include a first generation module 610, an acquisition module 620, and a second generation module 630.

The first generation module 610 is used to generate at least one initial response information according to a query information provided by an object.

The acquisition module 620 is used to acquire at least one feedback information corresponding to the at least one initial response information.

In embodiments of the present disclosure, the feedback information indicates a preference degree of the object for the initial response information.

The second generation module 630 is used to generate a training sample according to the query information, the at least one initial response information and the at least one feedback information.

In some embodiments, the first generation module includes: a first generation sub-module used to generate the at least one initial response information using a conversational model according to the query information.

In some embodiments, the object includes a user and/or a large model, and the feedback information includes a target response information provided by the object and/or a preference degree value.

In some embodiments, a preference degree of the object for the target response information is greater than the preference degree of the object for the initial response information, and the acquisition module includes at least one of: an first acquisition sub-module used to acquire the target response information provided by the object and corresponding to the query information, wherein a correlation index value between the target response information and the initial response information is less than a preset correlation threshold; and an second acquisition sub-module used to acquire the target response information provided by the object and obtained by editing the initial response information by the object.

In some embodiments, the feedback information is generated by the large model according to a preset feedback rule and the initial response information, and the preset feedback rule is determined according to a preference of the user.

In some embodiments, the preference degree value is determined according to one of a plurality of visual controls triggered by the user, the plurality of visual controls include a first visual control and a second visual control, and a preference degree value corresponding to the first visual control is greater than a preference degree value corresponding to the second visual control.

It should be understood that the above describes the apparatus for processing a query-response information of the present disclosure, and the apparatus for training a model of the present disclosure will be described below.

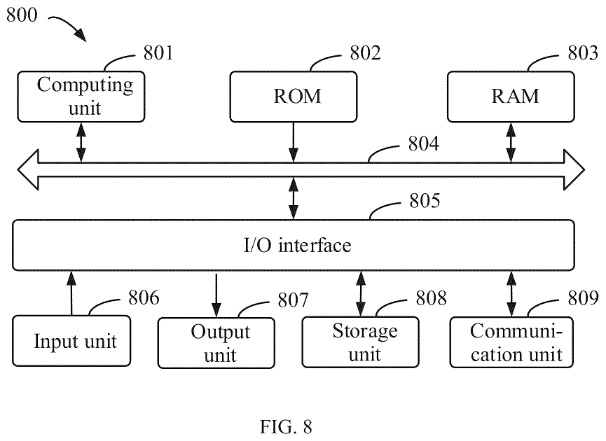

FIG. 7 is a block diagram of an apparatus for training a conversational model according to another embodiment of the present disclosure.

As shown in FIG. 7, the apparatus 700 may include an adjustment module 740.

The adjustment module 740 is used to adjust a parameter of the conversational model according to at least one training sample, so that the conversational model generates an adjusted response information according to a query information in the training sample.

In embodiments of the present disclosure, a difference between the adjusted response information and a response information with a high preference degree in the training sample is small, and a difference between the adjusted response information and a response information with a low preference degree in the training sample is large.

In embodiments of the present disclosure, the training sample is generated by using: a first generation module used to generate at least one initial response information according to a query information provided by an object; an acquisition module used to acquire at least one feedback information corresponding to the at least one initial response information, wherein the feedback information indicates a preference degree of the object for the initial response information; and a second generation module used to generate the training sample according to the query information, the at least one initial response information and the at least one feedback information.

In some embodiments, the feedback information includes a preference degree value, and the adjustment module includes: a first adjustment sub-module used to adjust the parameter of the conversational model according to the query information, the initial response information and the preference degree value in the training sample.

In some embodiments, the adjustment module further includes: a first adjustment unit used to adjust the parameter of the conversational model based on the Kahneman-Tversky optimization method.

In some embodiments, the training sample includes a plurality of initial response information, the feedback information includes a preference degree value. The adjustment module includes: a second adjustment sub-module used to adjust the parameter of the conversational model according to the query information, the plurality of initial response information and respective preference degree values of the plurality of initial response information in the training sample.

In some embodiments, the feedback information includes a target response information provided by the object, a preference degree of the object for the target response information is greater than the preference degree of the object for the initial response information. The adjustment module includes: a third adjustment sub-module used to adjust the parameter of the conversational model according to the query information, the initial response information and the target response information in the training sample.

In some embodiments, the adjustment module further includes: a second adjustment unit used to adjust the parameter of the conversational model based on at least one of direct preference optimization, simple preference optimization, or proximal strategy optimization.

It should be noted that, collecting, storing, using, processing, transmitting, providing, and disclosing of the relevant data involved in the technical solution of the present disclosure comply with the provisions of relevant laws and regulations, and do not violate public order and good customs.

According to embodiments of the present disclosure, the present disclosure further provides an electronic device, a readable storage medium and a computer program product.

FIG. 8 shows a schematic block diagram of an example electronic device 800 used to implement embodiments of the present disclosure. The electronic device is intended to represent various forms of digital computers, such as laptop computers, desktop computers, workstations, personal digital assistants, servers, blade servers, mainframe computers and other suitable computers. The electronic device may also represent various forms of mobile devices, such as personal digital processing, cellular phones, smart phones, wearable devices and other similar computing devices. The components shown herein, their connections and relationships, and their functions are merely examples, and are not intended to limit the implementation of the present disclosure described and/or required herein.

As shown in FIG. 8, the device 800 includes a computing unit 801, which may execute various appropriate actions and processing according to a computer program stored in a read only memory (ROM) 802 or a computer program loaded from a storage unit 808 into a random access memory (RAM) 803. Various programs and data required for the operation of the device 800 may also be stored in the RAM 803. The computing unit 801, the ROM 802 and the RAM 803 are connected to each other through a bus 804. An input/output (I/O) interface 805 is also connected to the bus 804.

The I/O interface 805 is connected to a plurality of components of the device 800, including: an input unit 806, such as a keyboard, a mouse, etc.; an output unit 807, such as various types of displays, speakers, etc.; a storage unit 808, such as a magnetic disk, an optical disk, etc.; and a communication unit 809, such as a network card, a modem, a wireless communication transceiver, etc. The communication unit 809 allows the device 800 to exchange information/data with other devices through the computer network such as the Internet and/or various telecommunication networks.

The computing unit 801 may be various general-purpose and/or special-purpose processing components with processing and computing capabilities. Some examples of computing unit 801 include, but are not limited to, central processing unit (CPU), graphics processing unit (GPU), various dedicated artificial intelligence (AI) computing chips, various processors that run machine learning model algorithms, digital signal processing DSP and any appropriate processor, controller, microcontroller, etc. The computing unit 801 executes the various methods and processes described above, such as the method for processing a query-response information and/or the method for training a conversational model. For example, in some embodiments, the method for processing a query-response information and/or the method for training a conversational model may be implemented as computer software programs, which are tangibly contained in the machine-readable medium, such as the storage unit 808. In some embodiments, part or all of the computer program may be loaded and/or installed on the device 800 via the ROM 802 and/or the communication unit 809. When the computer program is loaded into the RAM 803 and executed by the computing unit 801, one or more steps of the method for processing a query-response information and/or the method for training a conversational model described above may be executed. Alternatively, in other embodiments, the computing unit 801 may be used to execute the method for processing a query-response information and/or the method for training a conversational model in any other suitable manner (for example, by means of firmware).

Various implementations of the systems and technologies described in the present disclosure may be implemented in digital electronic circuit systems, integrated circuit systems, field programmable gate arrays (FPGA), application specific integrated circuits (ASIC), application-specific standard products (ASSP), system-on-chip SOC, load programmable logic device (CPLD), computer hardware, firmware, software and/or their combination. The various implementations may include: being implemented in one or more computer programs, the one or more computer programs may be executed and/or interpreted on a programmable system including at least one programmable processor, the programmable processor may be a dedicated or general programmable processor. The programmable processor may receive data and instructions from a storage system, at least one input device and at least one output device, and the programmable processor transmit data and instructions to the storage system, the at least one input device and the at least one output device.

The program code used to implement the methods of the present disclosure may be written in any combination of one or more programming languages. The program codes may be provided to the processors or controllers of general-purpose computers, special-purpose computers or other programmable data processing devices, so that the program code enables the functions/operations specific in the flowcharts and/or block diagrams to be implemented when the program code executed by a processor or controller. The program code may be executed entirely on the machine, partly executed on the machine, partly executed on the machine and partly executed on the remote machine as an independent software package, or entirely executed on the remote machine or server.

In the context of the present disclosure, the machine-readable medium may be a tangible medium, which may contain or store a program for use by the instruction execution system, apparatus, or device or in combination with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage media would include electrical connections based on one or more wires, portable computer disks, hard disks, random access memory (RAM), read only memory (ROM), erasable programmable read only memory (EPROM or flash memory), optical fiber, portable compact disk read only memory (CD-ROM), optical storage device, magnetic storage device or any suitable combination of the above-mentioned content.

In order to provide interaction with users, the systems and techniques described here may be implemented on a computer, the computer includes: a display device (for example, a CRT (cathode ray tube) or LCD (liquid crystal display) monitor) for displaying information to the user; and a keyboard and a pointing device (for example, a mouse or trackball). The user may provide input to the computer through the keyboard and the pointing device. Other types of devices may also be used to provide interaction with users. For example, the feedback provided to the user may be any form of sensory feedback (for example, visual feedback, auditory feedback or tactile feedback); and any form (including sound input, voice input, or tactile input) may be used to receive input from the user.

The systems and technologies described herein may be implemented in a computing system including back-end components (for example, as a data server), or a computing system including middleware components (for example, an application server), or a computing system including front-end components (for example, a user computer with a graphical user interface or a web browser through which the user may interact with the implementation of the system and technology described herein), or in a computing system including any combination of such back-end components, middleware components or front-end components. The components of the system may be connected to each other through any form or medium of digital data communication (for example, a communication network). Examples of communication networks include: local area network (LAN), wide area network (WAN) and the Internet.

The computer system may include a client and a server. The client and the server are generally far away from each other and usually interact through the communication network. The relationship between the client and the server is generated by computer programs that run on the respective computers and have a client-server relationship with each other.

It should be understood that the various forms of processes shown above may be used to reorder, add or delete steps. For example, the steps described in the present disclosure may be executed in parallel, sequentially or in a different order, as long as the desired result of the present disclosure may be achieved, which is not limited herein.

The above-mentioned specific implementations do not constitute a limitation on the protection scope of the present disclosure. Those skilled in the art should understand that various modifications, combinations, sub-combinations and substitutions may be made according to design requirements and other factors. Any modification, equivalent replacement and improvement made within the spirit and principle of the present disclosure shall be included in the protection scope of the present disclosure.

What is claimed is:

1. A method for processing a query-response information, comprising:
generating at least one initial response information according to a query information provided by an object;
acquiring at least one feedback information corresponding to the at least one initial response information, wherein the feedback information indicates a preference degree of the object for the initial response information; and
generating a training sample according to the query information, the at least one initial response information and the at least one feedback information.

2. The method according to claim 1, wherein the generating at least one initial response information according to a query information provided by an object comprises:
generating the at least one initial response information using a conversational model according to the query information.

3. The method according to claim 1, wherein the object comprises a user and/or a large model, and the feedback information comprises a target response information provided by the object and/or a preference degree value.

4. The method according to claim 3, wherein a preference degree of the object for the target response information is greater than the preference degree of the object for the initial response information,
the acquiring at least one feedback information corresponding to the at least one initial response information comprises at least one of:
acquiring the target response information provided by the object and corresponding to the query information, wherein a correlation index value between the target response information and the initial response information is less than a preset correlation threshold; and
acquiring the target response information provided by the object and obtained by editing the initial response information by the object.

5. The method according to claim 3, wherein the feedback information is generated by the large model according to a preset feedback rule and the initial response information, and the preset feedback rule is determined according to a preference of the user.

6. The method according to claim 3, wherein the preference degree value is determined according to one of a plurality of visual controls triggered by the user, the plurality of visual controls comprise a first visual control and a second visual control, and a preference degree value corresponding to the first visual control is greater than a preference degree value corresponding to the second visual control.

7. A method for training a conversational model, comprising:
adjusting a parameter of the conversational model according to at least one training sample, so that the conversational model generates an adjusted response information according to a query information in the training sample, wherein a difference between the adjusted response information and a response information with a high preference degree in the training sample is small, and a difference between the adjusted response information and a response information with a low preference degree in the training sample is large,
wherein the training sample is generated by:
generating at least one initial response information according to a query information provided by an object;
acquiring at least one feedback information corresponding to the at least one initial response information, wherein the feedback information indicates a preference degree of the object for the initial response information; and
generating the training sample according to the query information, the at least one initial response information and the at least one feedback information.

8. The method according to claim 7, wherein the feedback information comprises a preference degree value, and
the adjusting a parameter of the conversational model according to at least one training sample comprises:
adjusting the parameter of the conversational model according to the query information, the initial response information and the preference degree value in the training sample.

9. The method according to claim 8, wherein the adjusting a parameter of the conversational model comprises:
adjusting the parameter of the conversational model based on the Kahneman-Tversky optimization method.

10. The method according to claim 7, wherein the training sample comprises a plurality of initial response information, the feedback information comprises a preference degree value,
the adjusting a parameter of the conversational model according to at least one training sample comprises:
adjusting the parameter of the conversational model according to the query information, the plurality of initial response information, and respective preference degree values of the plurality of initial response information in the training sample.

11. The method according to claim 7, wherein the feedback information comprises a target response information provided by the object, a preference degree of the object for the target response information is greater than the preference degree of the object for the initial response information,
the adjusting a parameter of the conversational model according to at least one training sample comprises:
adjusting the parameter of the conversational model according to the query information, the initial response information and the target response information in the training sample.

12. The method according to claim 9, wherein the adjusting the parameter of the conversational model comprises:
adjusting the parameter of the conversational model based on at least one of direct preference optimization, simple preference optimization, or proximal strategy optimization.

13. The method according to claim 10, wherein the adjusting the parameter of the conversational model comprises:
adjusting the parameter of the conversational model based on at least one of direct preference optimization, simple preference optimization, or proximal strategy optimization.

14. An electronic device, comprising:
at least one processor; and
a memory communicatively connected with the at least one processor;
wherein the memory stores instructions executable by the at least one processor, and the instructions, when executed by the at least one processor, are configured to cause the at least one processor to at least:
generate at least one initial response information according to a query information provided by an object;
acquire at least one feedback information corresponding to the at least one initial response information, wherein the feedback information indicates a preference degree of the object for the initial response information; and
generate a training sample according to the query information, the at least one initial response information and the at least one feedback information.

15. The electronic device according to claim 14, wherein the instructions are further configured to cause the at least one processor to at least:
generate the at least one initial response information using a conversational model according to the query information.

16. The electronic device according to claim 14, wherein the object comprises a user and/or a large model, and the feedback information comprises a target response information provided by the object and/or a preference degree value.

17. The electronic device according to claim 16, wherein a preference degree of the object for the target response information is greater than the preference degree of the object for the initial response information,
the instructions are further configured to cause the at least one processor to implement at least one of following operations:
acquiring the target response information provided by the object and corresponding to the query information, wherein a correlation index value between the target response information and the initial response information is less than a preset correlation threshold; and
acquiring the target response information provided by the object and obtained by editing the initial response information by the object.

18. An electronic device, comprising:
at least one processor; and
a memory communicatively connected with the at least one processor;
wherein the memory stores instructions executable by the at least one processor, and the instructions, when executed by the at least one processor, are configured to cause the at least one processor to implement the method of claim 7.

19. A non-transitory computer-readable storage medium having computer instructions stored therein, wherein the computer instructions are configured to cause a computer to implement the method of claim 1.

20. A non-transitory computer-readable storage medium having computer instructions stored therein, wherein the computer instructions are configured to cause a computer to implement the method of claim 7.
